(19) United States
(12) Patent Application Publication
(10) Pub. No.: US 2016/0182320 A1
(43) Pub. Date: Jun. 23, 2016

(54) TECHNIQUES TO GENERATE A GRAPH MODEL FOR CLOUD INFRASTRUCTURE ELEMENTS

(71) Applicant: Intel Corporation, Santa Clara, CA (US)

(72) Inventors: KATALIN K. BARTFAI-WALCOTT, El Dorado Hills, CA (US); ALEXANDER LECHEY, Kilcock (IE); THIJS METSCH, Koln (DE); JOSEPH BUTLER, Stamullen Co Meath (IE); JONATHAN DONALDSON, Hillsboro, OR (US); MICHAEL J. MCGRATH, Virginia (IE)

(73) Assignee: Intel Corporation, Santa Clara, CA (US)

(21) Appl. No.: 14/582,102

(22) Filed: Dec. 23, 2014

(51) Int. Cl. H04L 12/26; H04L 12/46; H04L 12/24

(52) U.S. Cl. CPC H04L 43/045; H04L 41/0803; H04L 12/4641

(57) ABSTRACT

Examples may include techniques to generate a graph model for cloud infrastructure elements. Information regarding the cloud infrastructure elements may be obtained. Logical layers may be assigned to each of the cloud infrastructure elements. The logical layers may include a physical layer for physical devices, an allocation layer for logical services composed of placed physical devices, a virtual layer for virtualized elements or a service layer for services or workloads implemented by the virtualized elements. In some examples, each cloud infrastructure element may be added to a graph model as nodes having metadata and attributes based on the obtained information.

### TECHNICAL FIELD

Examples described herein are generally related to pooled or configurable computing resources.

### BACKGROUND

Software define infrastructure (SDI) is a technological advancement that enables new ways to operate large pools of configurable computing resources deployed for use in a datacenter or as part of a cloud infrastructure. SDI may allow individual elements of a system of configurable computing resources to be composed with software. These elements may include physical elements, logically placed physical elements, virtual elements or service/workload elements.

### BRIEF DESCRIPTION OF THE DRAWINGS

FIG. 1 illustrates an example cloud infrastructure.

FIG. 2 illustrates example logical layers.

FIG. 3 illustrates an example table.

FIG. 4 illustrates an example process.

FIG. 5 illustrates an example first element node.

FIG. 6 illustrates an example second element node.

FIG. 7 illustrates an example first relationship.

FIG. 8 illustrates an example third element node.

FIG. 9 illustrates an example second relationship.

FIG. 10 illustrates an example fourth element node.

FIG. 11 illustrates an example third relationship.

FIG. 12 illustrates an example graph portion.

FIG. 13 illustrates an example context node.

FIG. 14 illustrates an example fourth relationship.

FIG. 15 illustrates an example block diagram for an apparatus.

FIG. 16 illustrates an example of a logic flow.

FIG. 17 illustrates an example of a storage medium.

FIG. 18 illustrates an example computing platform.

### DETAILED DESCRIPTION

As contemplated in the present disclosure, SDI may allow individual elements of a system of configurable computing resources to be composed with software. Physical elements may include disaggregated physical elements that may be composed with software such as central processing units (CPUs), storage devices (e.g., hard/solid state disk drives), memory (e.g., random access memory), network input/output devices (e.g., network interface cards) or network switches. Virtualized elements may include virtual machines (VMs), virtual local access networks (vLANs), block storage (virtual storage volumes) or virtual switches (vSwitches). Service elements may include management services, message queue services or security services. Workloads may include databases, webservers, video processing.

The above-mentioned elements may be arranged in complex and large arrangements of interrelated pieces when composed to support a cloud infrastructure. Current cloud infrastructure management tools lack an ability to quickly understand how all these elements are connected and what dependencies or relationships may exist in order to make rapid/automated administrative or management decisions. Over time, hardware or disaggregated physical elements may be added/removed, services start-up/shutdown or new VMs are created/destroyed or migrated across hardware. How to incorporate these changes in a graph model that shows a landscape view of a cloud infrastructure is problematic. Also, obtaining snapshots or versions of the graph model at given periods of time to measure performance may also be problematic due to the changing and complex landscape of cloud infrastructure. It is with respect to these challenges that the examples described herein are needed.

According to some examples, techniques to generate a graph model for cloud infrastructure elements may include querying, at a processor circuit, information for elements of a system of configurable computing resources of a cloud infrastructure. A logical layer may then be assigned to each element of the system of configurable computing resources. The logical layer may be assigned from one of a physical layer, an allocation layer, a virtual layer or a service layer. Each element may then be added to a graph model as separate element nodes each having metadata and attributes that are based, at least in part, on the queried information and the assigned logical layer.

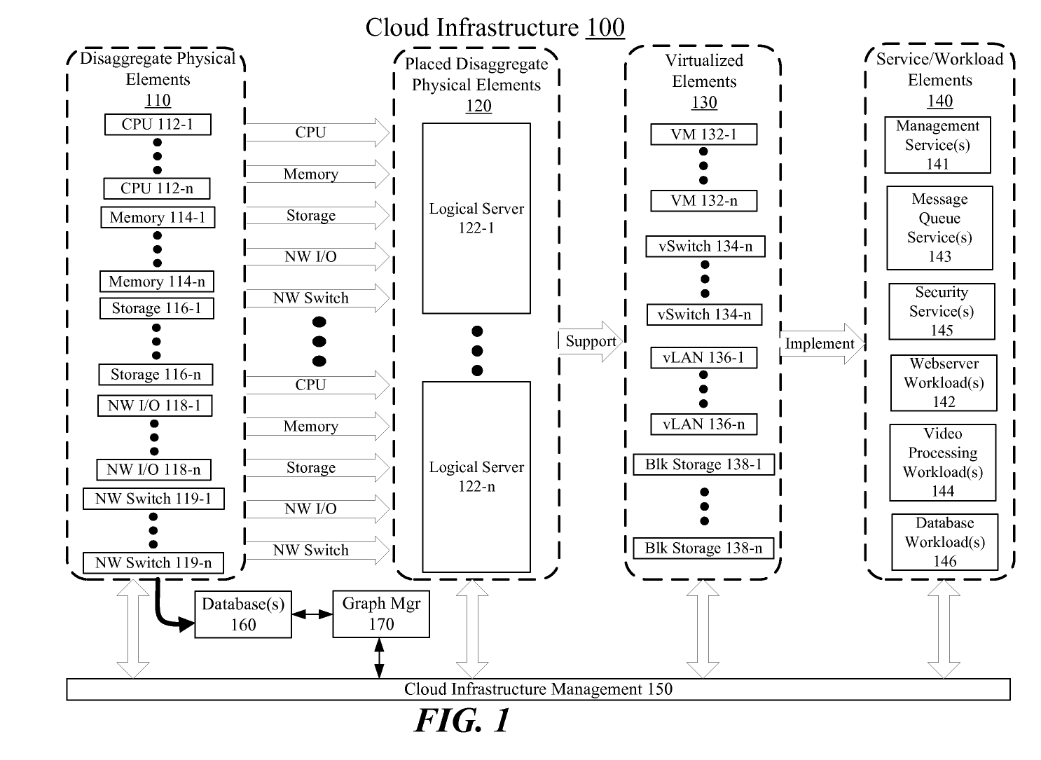

FIG. 1 illustrates an example cloud infrastructure 100. In some examples, as shown in FIG. 1, cloud infrastructure 100 includes disaggregate physical elements 110, placed disaggregate physical elements 120, virtualized elements 130 or service/workload elements 140. In some examples, a cloud infrastructure management 150 may be arranged to manage or control at least some aspects of disaggregate physical elements 110, placed disaggregate physical elements 120, virtualized elements 130 or service/workload elements 140. As described more below, in some examples, a graph manager 170 may be capable of querying cloud infrastructure management 150 and database(s) 160 to gather information for a graph model that may be used to provide a landscape view of a cloud infrastructure such as cloud infrastructure 100.

According to some examples, as shown in FIG. 1, disaggregate physical elements 110 may include CPUs 112-1 to 112-n, where “n” is any positive integer greater than 1. CPUs 112-1 to 112-n may individually represent single microprocessors or may represent separate cores of a multi-core microprocessor. Disaggregate physical elements 110 may also include memory 114-1 to 114-n. Memory 114-1 to 114-n may represent various types of memory devices such as, but not limited to, dynamic random access memory (DRAM) devices that may be included in dual in-line memory modules (DIMMs) or other configurations. Disaggregate physical elements 110 may also include storage 116-1 to 116-n. Storage 116-1 to 116-n may represent various types of storage devices such as hard disk drives or solid state disk drives. Disaggregate physical elements 110 may also include network (NW) input/outputs (I/Os) 118-1 to 118-n. NW I/Os 118-1 to 118-n may include network interface cards (NICs) having one or more NW ports for network connections for NWs within cloud infrastructure 100 or external to cloud infrastructure 100. Disaggregate physical elements 110 may also include NW switches 119-1 to 119-n. NW switches 119-1 to 119-n may be capable of routing data via either internal or external network links for elements of cloud infrastructure 100.

In some examples, as shown in FIG. 1, placed disaggregate physical elements 120 may include logical servers 122-1 to 122-n. For these examples, groupings of CPU, memory, storage, NW I/O or NW switch elements from disaggregate physical elements may be placed in a logic configuration. Each logical configuration may include any number or combination of CPU, memory, storage, NW I/O or NW switch elements to form a logical server such as logical server 122-1.

According to some examples, as shown in FIG. 1, virtualized elements 130 may include VMs 132-1 to 132-n, vSwitches 134-1 to 134-n, vLANs 136-1 to 136-n or virtual storage volumes/block storage 138-1 to 138-n. For these examples, each of these virtualized elements may be supported by a given logical server from among logical servers 122-1 to 122-n of placed disaggregate physical elements 120. For example, VM 132-1 may be supported by logical server 122-1 and may also be supported by disaggregate physical elements such as CPU 112-1 that may have been placed with logical server 122-1.

In some examples, virtualized elements 130 may be arranged to execute service/workload elements 140. As shown in FIG. 1, in some examples, service/workload elements 140 may include management service(s) 141, message queue service(s) 143, security service(s) 145, webserver workload(s) 142, video processing workload(s) 144 or database workload(s) 146. For these examples, VMs, vSwitches, vLANs or block storage from virtualized elements 130 may be used to implement service/workload elements 140. For example, management service(s) 141 may use VM 132-1 to execute management related applications, video processing workload(s) 144 may use block storage 136-1 for streaming video or message queue service(s) may use vSwitch 134-n and/or vLAN 134-n to facilitate use of a multitude of message queues.

According to some examples, database(s) 160 may include information related to disaggregate physical elements 110. For these examples, database(s) 160 may include one or more databases for network elements, storage elements or compute elements. Databases for network elements, for example, may include operating characteristics and/or capabilities for NW I/Os 118-1 to 118-n or NW switches 119-1 to 119-n. For example, number of ports or connections supported, data throughput capabilities, etc. Databases for storage elements may include operating characteristics and/or capabilities for storage 116-1 to 116-n. For example, storage capacities, types of storage (e.g., hard disk or solid state), read/write rates, etc. Databases for compute elements may include operating characteristics and/or capabilities for CPUs 112-1 to 112-n or memory 114-1 to 114-n. For example, CPU operating frequencies, CPU cache capacities, types of CPU cache, memory capacity, types of memory, memory read/write rates, etc. Each database included in database(s) 160 may also include unique identifier information for each element for disaggregate physical elements 110. The unique identifier information may be based on a universally unique identifier (UUID) system.

In some examples, cloud infrastructure management 150 may also maintain information such as unique identifier information for each element for disaggregate physical elements 110. Cloud infrastructure manager 150 may also maintain operating characteristics or capabilities for elements included in placed disaggregate physical elements 120, virtualized elements 130 or service/workload elements 140. Cloud infrastructure manager 150 may also be arranged to maintain information on how the various elements of cloud infrastructure 100 are arranged or configured to operate. For example, what disaggregate physical elements 110 are used for what logical servers included in placed disaggregate physical elements 120. Further, what logical servers support virtualized elements 130 and what virtualized elements 130 implement service/workload elements 140.

According to some examples, cloud infrastructure management 150 may include one or more monitoring services to monitor performance of the various elements of cloud infrastructure 100 to provide contextualized information. For example, the monitoring services may monitor performance for a given element to meet a quality of service (QoS) or a service-level agreement (SLA) requirement over one or more time periods or intervals. Cloud infrastructure management 150 may be capable of at least temporarily maintaining this contextualized information.

In some examples, logic and/or features such as logic and/or features for graph manager 170 may be capable of querying information for elements of cloud infrastructure 100 from both database(s) 160 and cloud infrastructure management 150. As described more below, that queried information, as well as assignment to a logical layer may be used for a graph model that includes various types of nodes providing a landscape view. The graph model may be used to determine relationships between elements and establish versions of the graph model to gauge performance over given periods of time. In other words, the graph model may provide an ability to query historical data for cloud infrastructure 100 that would allow workload placements to be analyzed, review what VM's were supported by which logical servers having what disaggregated physical elements. Also, the query of historical data using the graph model may indicate what services were active or alive during its lifespan and associated operating characteristics or capabilities. Having enough historical data may enable operators of cloud infrastructure 100 to generate workload fingerprints that may lead to recommendations on how the various elements may be placed to operate cloud infrastructure 100 in a more efficient manner.

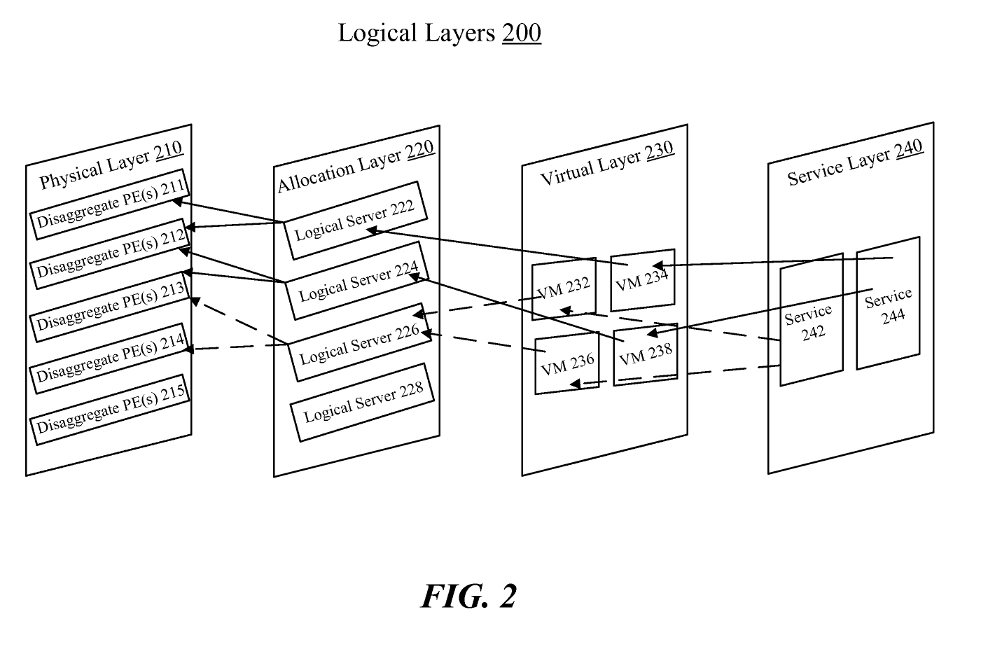

FIG. 2 illustrates example logical layers 200. As shown in FIG. 2, logical layers 200 include physical layer 210, allocation layer 220, virtual layer 230 and service layer 240. According to some examples, elements of a system of configurable computing resources of a cloud infrastructure such as those elements shown in FIG. 1 may be assigned to one of the four layers for logical layers 200 following a query for information regarding these elements. For these examples, the query may be from a combination of cloud infrastructure management and one or more databases (e.g., database(s) 160).

In some examples, as shown in FIG. 2, hardware components such as disaggregate physical elements (PEs) 211 to 215 may be assigned to physical layer 210. As mentioned above for FIG. 1, disaggregate PEs may include CPUs, memory, storage, NW I/O or NW switches.

According to some examples, as shown in FIG. 2, logical machines or servers such as logical servers 222 to 228 may be assigned to allocation layer 220. As mentioned above for FIG. 1, each logical server may include combinations of placed disaggregated PEs.

In some examples, as shown in FIG. 2, software defined or virtualized components such as VMs 232 to 238 may be assigned to virtual layer 230. As mentioned above for FIG. 1, virtualized components may include VMs, vSwitches, vLANs or block storage.

According to some examples, as shown in FIG. 2, currently running services such as services 242 and 244 may be assigned to service layer 240. Although not shown in FIG. 2, workloads may also be assigned to service layer 240. As mentioned above for FIG. 1, service/workload components may include management services, message queue services, security services, webserver workloads, video processing workloads or database workloads.

According to some examples, mapping of various elements assigned to each logical layer of logical layer 200 may show relationships between the various elements. For example, as shown in FIG. 2, the solid-line arrows originating from service 244 at service layer 240 shows a relationship with VMs 234 and 238 at virtual layer 230 via a mapping between these elements assigned to service layer 240 and virtual layer 230. The solid-line arrow from VM 238 at virtual layer 230 shows a relationship with logical server 224 at allocation layer 220 via a mapping between these elements assigned to virtual layer 230 and allocation layer 220. The solid-line arrows from logical server 224 at allocation layer 220 shows a relationship with disaggregate PE(s) 213 and 212 via a mapping between these elements assigned to allocation layer 220 and physical layer 210.

In some examples, SLA or QoS requirements for each element tied to a given service may be monitored across the mapped elements between the layers of logical layers 200. For example, QoS requirements for service 244 may be monitored not only at service 244 but also at VMs 234 and 238, logical servers 222 and 224 and at disaggregate PE(s) 211, 212, and 213. This monitoring between the layers may be demonstrated by following the solid-line arrows originating at service 244 and ending at disaggregate PE(s) 211, 212, and 213. As described more below, each element of a system of configurable computing resources of a cloud infrastructure may be added to a graph model as separate element nodes each having metadata and attributes that may be based, at least in part, on information that may have been queried as mentioned above for FIG. 1 and also based on an assigned logical layer as described for FIG. 2.

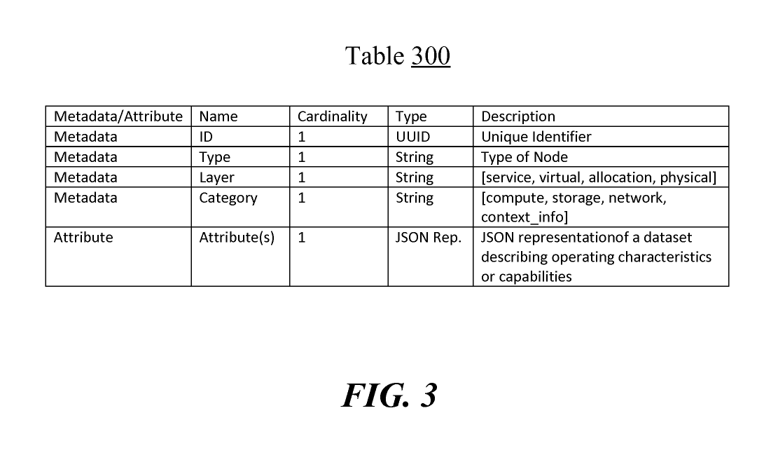

FIG. 3 illustrates an example table 300. In some examples, table 300 includes a description of metadata and attributes information that may be gathered for each element of a system of configurable computing resources of a cloud infrastructure. The information gathered for each element, for example, may be for an element node to be added to graph model of the cloud infrastructure. In other examples, contextualized information for a given element may also be gathered, the contextualized information gathered for the given element, for example, may be for a context node to be added to the graph model of the cloud infrastructure.

In some examples, table 300 shows whether the information gathered or queried is metadata or an attribute, a name for the information, cardinality for the information, type or format for how the information is conveyed and a description for the metadata or attribute. As shown in FIG. 3, metadata named as “ID” has a cardinality of 1, may have a UUID type and is described as a unique identifier. Also as shown in FIG. 3, metadata named as “type” has a cardinality of 1, may have a string type and indicates a type of node (e.g., element or context). Also as shown in FIG. 3, metadata named as “layer” has a cardinality of 1, may have a string type and indicates which logical layer (service, virtual, allocation or physical) was assigned to the element. Also as shown in FIG. 3, metadata named as “category” has a cardinality of 1, may have a string type and indicates whether the element is categorized as compute, storage, network or context information. Also as shown in FIG. 3, attribute named “attribute(s)” has a cardinality of 1, may have a JavaScript Object Notation (JSON) representation type and indicates a dataset describing operating characteristics or capabilities.

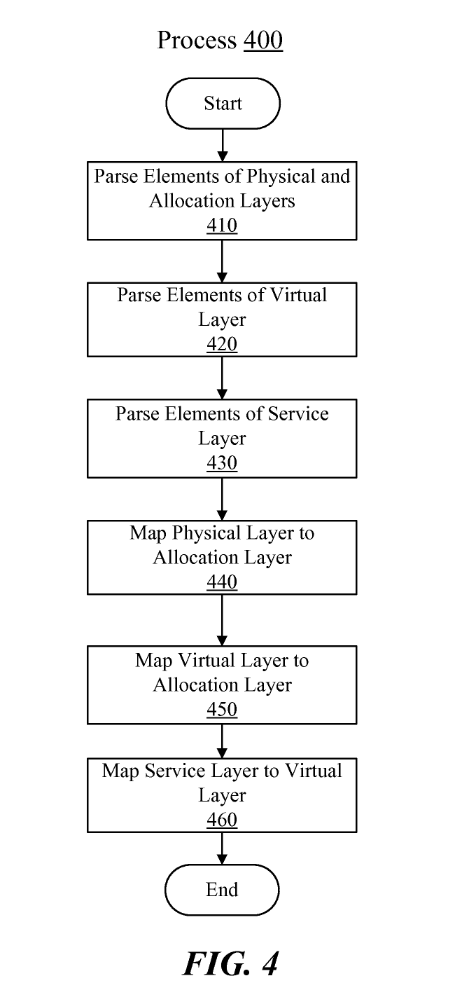

FIG. 4 illustrates an example process 400. According to some examples, process 400 may be for logic and/or features capable of creating a graph model for elements of a system of configurable computing resources such as the elements shown in FIG. 1 for cloud infrastructure 100. For these examples, components of system 100 as shown in FIG. 1 such as cloud infrastructure management 150, database(s) 160 or graph manager 170 may be related to process 500. Allocation of physical layers as described for FIG. 2 or organizing of queried information as described for FIG. 3 may also be related to process 400. However, the example process 400 is not limited to implementations using components of cloud infrastructure 100, logical layers 200 or table 300 as shown or described in FIGS. 1-3.

Moving from the start to block 410 (Parse Elements of Physical and Allocation Layers), graph manager 170 may include logic and/or features to query information for elements of cloud infrastructure 100 that have been assigned to physical and allocation layers. According to some examples, disaggregated PEs 110 may be assigned to a physical layer similar to physical layer 210 of FIG. 2. Also, for these examples, placed disaggregate physical elements 120 may be assigned to an allocation layer similar to allocation layer 220 of FIG. 2.

In some examples, the queried information for disaggregated PEs 110 and for placed disaggregated PEs 120 may be parsed to determine operating characteristics or capabilities. For example, feature sets for CPU 112-1 to 112-n, memory 114-1 to 114-n, storage 116-1 to 116-n, NW I/Os 118-1 to 118-n or NW switches 119-1 to 119-n may be parsed from the queried information. In other examples, logical server capabilities such as number of CPUs, memory, storage, NW I/O ports, etc. may be parsed to determine operating characteristics or capabilities for logical servers 122-1 or 122-2. In some examples, the determined feature sets may be included in attributes for each disaggregate PE or placed disaggregated PE (logical server) that may be added as a node to a graph model generated by graph manager 170.

Moving from block 410 to block 420 (Parse Elements of Virtual Layer), graph manager 170 may include logic and/or features to query information for elements of cloud infrastructure 100 that have been assigned to a virtual layer. According to some examples, virtualized elements 130 may be assigned to a virtual layer similar to virtual layer 230 of FIG. 2. The queried information may indicate how many VMs are currently running, virtual storage volumes or block storage available, how many vLANs are in use, subnets and mapped relationships to vLAN(s), ports and attach to networks or devices, attach ports to VMs or load balance information (e.g., from load balancers) associated with one or more virtualized elements 130.

In some examples, queried information for virtualized elements 130 may be parsed to determine operating characteristics or capabilities. For example, feature sets associated with VMs 132-1 to 132-n, vSwitches 134-1 to 134-n, vLANs 136-1 to 136-n or block storage 138-1 to 138-n may be determined from the parsed information. The determined feature sets may be included in attributes for each virtualized element that may be added as a node to a graph model generated by graph manager 170.

Moving from block 420 to block 430 (Parse Elements of Service Layer), graph manager 170 may include logic and/or features to query information for elements of cloud infrastructure 100 that may have been assigned to a service layer. According to some examples, service/workload elements 140 may be assigned to a service layer similar to service layer 240 of FIG. 2. The queried information may include a list of services or workloads currently running as well as associated metadata. In some examples, the queried information for service/workload elements 140 may be parsed to determine operating characteristics or capabilities. For example, feature sets associated with management service(s) 141, message queue service(s) 143, security service(s) 145, webserver workload(s) 142, video processing workload(s) 144 or database workload(s) 146 may be determined from the parsed information. The determined feature sets may be included in attributes for each service/workload element that may be added as a node to a graph model generated by graph manager 170.

Moving from block 430 to block 440 (Map Physical Layer to Allocation Layer), graph manager 170 may include logic and/or features to map individual disaggregate PEs from among disaggregate PEs 110 assigned to the physical layer to the allocation layer based on whether an individual disaggregate PE is included in placed disaggregate PEs included in a respective logical server from among logical servers 122-1 and 122-2. In other words, hardware components of each physical machine (disaggregate PE) assigned to the physical layer may be mapped to a hosting logical server assigned to the allocation layer.

Moving from block 440 to block 450 (Map Virtual Layer to Allocation Layer), graph manager 170 may include logic and/or features to map to the allocation layer individual virtualized elements from among virtualized elements 130 assigned to the virtual layer. This mapping may be based on whether an individual virtualized element is supported by a respective logical server from among logical servers 122-1 and 122-2. In other words, all virtualized elements may be mapped to their supporting logical server which is further mapped to the hardware components that make up that that supporting logical server.

Moving from block 450 to block 460 (Map Service Layer to Virtual Layer), graph manager 170 may include logic and/or features to map to the virtual layer individual service or workload elements from among service/workload elements 140 assigned to the service layer. This mapping may be based on whether an individual service or workload element is implemented by a respective virtualized element from among virtualized elements 130. In other words, all service/workload elements may be mapped to implementing virtualized elements or virtual resources that may be utilized or consumed by these service/workload elements. Process 400 may then come to an end.

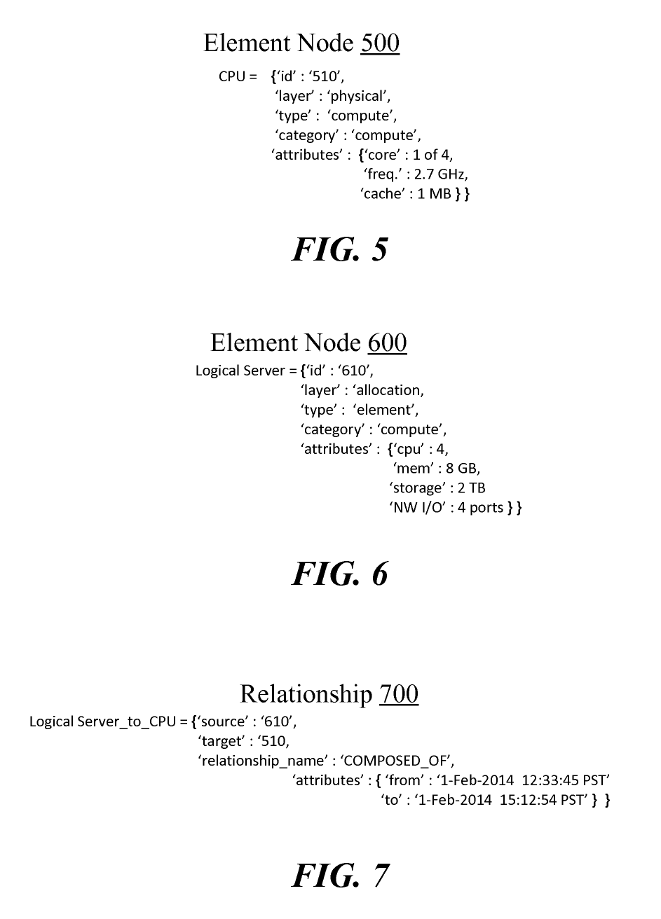

FIG. 5 illustrates an example first element node. As shown in FIG. 5, the first element node includes an element node 500. According to some examples, element node 500 may be an element node added to a graph model for a system of configurable computing resources of a cloud infrastructure similar to cloud infrastructure 100 of FIG. 1. For these examples, metadata and attributes based, at least in part, on queried information and an assigned logical layer may be included with element node 500. As shown in FIG. 5, element node 500 may be for a CPU. Also, for these examples, element node 500 may include metadata that indicates an ‘id’ or identifier of 510, a ‘layer’ or assigned logical layer of physical, a ‘type’ that indicates an element type of node and a ‘category’ of compute.

In some examples, element node 500 may also have attributes that indicate at least some operating characteristics or capabilities of the CPU. For example, as shown in FIG. 5, operating characteristics or capabilities of the CPU may include an indication of which core of a number of cores the CPU may be a part of as 1 of 4, an operating frequency of 2.7 GHz and a cache size of 1 MB. More or less operating characteristics or capabilities may be included in the attributes for a CPU element node, examples are not limited to the operating characteristics or capabilities shown in FIG. 5 for element node 500.

According to some examples, similar types of element nodes may be added to a graph model for other types of disaggregate PEs such as memory, storage, NW I/O or NW switches. However, types, category or attributes may vary based on the type of disaggregate PE included in a given element node.

FIG. 6 illustrates an example second element node. As shown in FIG. 6, the second element node includes an element node 600. According to some examples, element node 600 may be an element node added to a graph model for a system of configurable computing resources of a cloud infrastructure similar to cloud infrastructure 100 of FIG. 1. For these examples, metadata and attributes based, at least in part, on queried information and an assigned logical layer may be included with element node 600. As shown in FIG. 6, element node 600 may be for a logical server. Also, for these examples, element node 600 may include metadata that indicates an ‘id’ or identifier of 610, a ‘layer’ or assigned logical layer of allocation, a ‘type’ that indicates an element type of node and a ‘category’ of compute.

In some examples, element node 600 may also have attributes that indicate at least some operating characteristics or capabilities of the logical server. For example, as shown in FIG. 6, operating characteristics or capabilities of the logical server may include an indication of the number of CPUs placed with the logical server as 4, memory placed as 8 gigabytes (GB), storage placed as 2 terabytes (TB) and NW I/O ports placed as 4 ports. More or less operating characteristics or capabilities may be included in the attributes for a logical server element node, examples are not limited to the operating characteristics or capabilities shown in FIG. 6 for element node 600.

FIG. 7 illustrates an example first relationship. As shown in FIG. 7, the first relationship includes relationship 700. According to some examples, relationship 700 may be determined by logic and/or features that generate the graph model including at least element nodes 500 and 600. For these examples, a relationship between the CPU (target 510) for element node 500 and the logical server (source 610) for element node 600 may be determined. Relationships may be determined according to Relationship Table I shown below:

Relationship Table I

| Relationship_Name | Basis for Relationship |
|---|---|
| COMPOSED_OF | Between Allocation and Physical Layers |
| CONNECTED_TO | For Edges within Allocation Layer |
| DEPLOYED_ON | Between Virtual and Allocation Layers |
| REQUIRES | Between Nodes within Virtual Layer |
| RUNS_ON | Between Service and Virtual Layers |
| DEPENDS_ON | Between Nodes with Service Layer |

Based on Relationship Table I, the relationship between element nodes 500 and 600 would be COMPOSED_OF since a CPU would be assigned to a physical layer and a logical server would be assigned to an allocation layer. As shown in FIG. 7, the ‘relationship_name’ indicates a COMPOSED_OF relationship.

In some examples, relationship 700 between elements node 500 and 600 may also track a date and times for which a relationship between the CPU and logical server was/is maintained. As shown in FIG. 7, ‘from’ may indicate a date/time the relationship began as 1 Feb. 2014 at 12/33:45 Pacific Standard Time (PST). Also, as shown in FIG. 7, ‘to’ may indicate a date/time the relationship ended as 1 Feb. 2014 at 15:12:54 PST. For current (not ended) relationships, the ‘to’ value may be set as a date relatively far in the future. When the relationship is ended or no longer maintained, the ‘to’ value may be updated to the date/time the relationship actually ended. This tracking of the date/times for a relationship such as relationship 700 may allow for a date-based version of the graph model that includes at least element nodes 500 and 600. The date-based version may allow for historical tracking of what the graph model may look at during given periods of time.

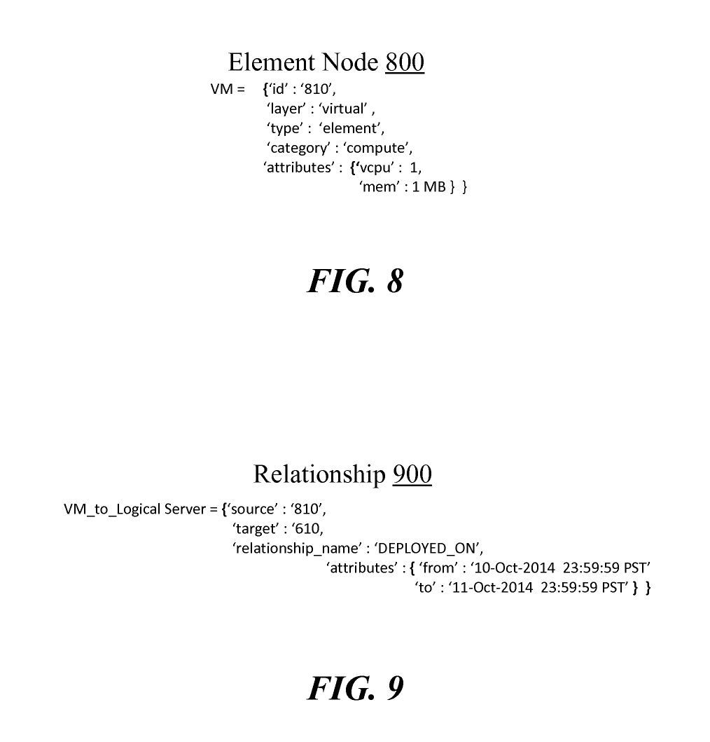

FIG. 8 illustrates an example third element node. As shown in FIG. 8, the third element node includes an element node 800. According to some examples, element node 800 may be an element node added to a graph model for a system of configurable computing resources of a cloud infrastructure similar to cloud infrastructure 100 of FIG. 1. For these examples, metadata and attributes based, at least in part, on queried information and an assigned logical layer may be included with element node 800. As shown in FIG. 8, element node 800 may be for a VM. Also, for these examples, element node 800 may include metadata that indicates an ‘id’ or identifier of 810, a ‘layer’ or assigned logical layer of virtual, a ‘type’ that indicates an element type of node and a ‘category’ of compute.

In some examples, element node 800 may also have attributes that indicate at least some operating characteristics or capabilities of the logical server. For example, as shown in FIG. 8, operating characteristics or capabilities of the VM may include a number of virtual CPUs (vCPUs) supporting the VM as 1 and an amount of memory supporting the VM as 1 megabyte (MB). More or less operating characteristics or capabilities may be included in the attributes for a VM element node, examples are not limited to the operating characteristics or capabilities shown in FIG. 8 for element node 800.

FIG. 9 illustrates an example second relationship. As shown in FIG. 9, the second relationship includes relationship 900. According to some examples, relationship 900 may be determined by logic and/or features that generate the graph model including at least element nodes 600 and 800. For these examples, a relationship between the logical server (target 610) for element node 600 and the VM (source 810) for element node 800 may be determined according to Relationship Table I as shown above. Based on Relationship Table I, the relationship between element nodes 600 and 800 would be DEPLOYED_ON since the logical server would be assigned to an allocation layer and the VM would be assigned to a virtual layer.

According to some examples, similar to relationship 700 shown in FIG. 7, relationship 900 may track date and times for which a relationship between the logical server and VM was/is maintained. As shown in FIG. 9, ‘from’ may indicate a date/time the relationship began as 10 Oct. 2014 at 23:59:59 PST. Also, as shown in FIG. 9, ‘to’ may indicate a date/time the relationship ended as 11 Oct. 2014 at 23:59:59 PST.

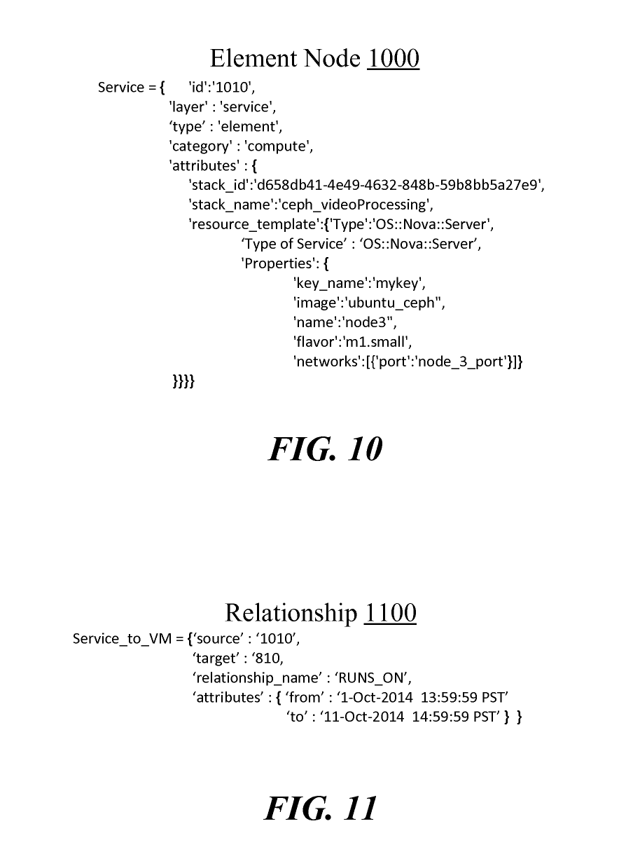

FIG. 10 illustrates an example fourth element node. As shown in FIG. 10, the fourth element node includes an element node 1000. According to some examples, element node 1000 may be an element node added to a graph model for a system of configurable computing resources of a cloud infrastructure similar to cloud infrastructure 100 of FIG. 1. For these examples, metadata and attributes based, at least in part, on queried information and an assigned logical layer may be included with element node 1000. As shown in FIG. 10, element node 1000 may be for a service. Also, for these examples, element node 1000 may include metadata that indicates an ‘id’ or identifier of 1010, a ‘layer’ or assigned logical layer of service, a ‘type’ that indicates an element type of node and a ‘category’ of compute.

In some examples, element node 1000 may also have attributes that indicate at least some operating characteristics or capabilities of the service. For example, as shown in FIG. 10, operating characteristics or capabilities of the service may indicate a ‘stack_id’, a ‘stack_name’, a ‘resource_template’ that may incorporate an indication of a ‘Type of Service’ and may further incorporate an indication of ‘Properties’ such as ‘key_name’, ‘image’, ‘name’, ‘flavor’ or ‘networks’. More or less operating characteristics or capabilities may be included in the attributes for a service element node, examples are not limited to the operating characteristics or capabilities shown in FIG. 10 for element node 1000.

FIG. 11 illustrates an example third relationship. As shown in FIG. 11, the third relationship includes relationship 1100. According to some examples, relationship 1100 may be determined by logic and/or features that generate the graph model including at least element nodes 800 and 1000 (e.g., located with a graph manager). For these examples, a relationship between the VM (target 810) for element node 800 and the service (source 1010) for element node 1000 may be determined according to Relationship Table I as shown above. Based on Relationship Table I, the relationship between element nodes 800 and 1000 would be RUNS_ON since the VM would be assigned to a virtual layer and the service would be assigned to a service layer.

According to some examples, similar to relationship 700 shown in FIG. 7, relationship 1100 may track date and times for which a relationship between the VM and the service was/is maintained. As shown in FIG. 11, ‘from’ may indicate a date/time the relationship began as 1 Oct. 2014 at 13:59:59 PST. Also, as shown in FIG. 9, ‘to’ may indicate a date/time the relationship ended as 11 Oct. 2014 at 14:59:59 PST.

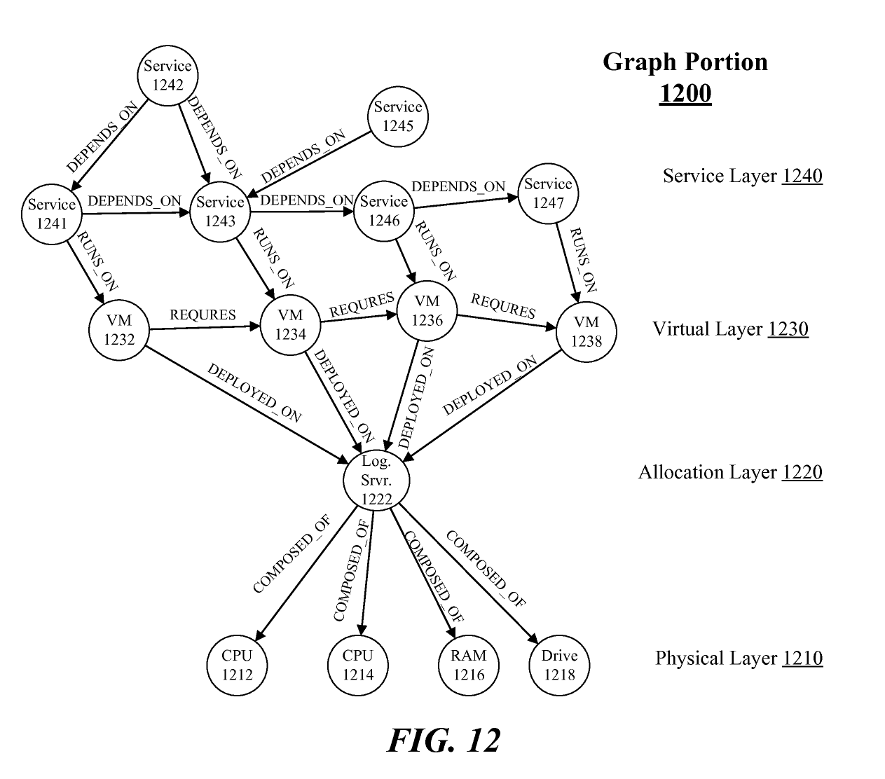

FIG. 12 illustrates an example graph portion 1200. In some examples, graph portion 1200 shows relationships between various element nodes assigned to various logical layers. For example, element nodes CPU 1212, CPU 1214, RAM 1216 and drive 1218 may be assigned to physical layer 1210 and may have a COMPOSED_OF relationship with logical server 1222 assigned to allocation layer 1220. Also, logical server 1222 may have a DEPLOYED_ON relationship with VMs 1232, 1234, 1236 and 1238 assigned to virtual layer 1230. Also, services 1241, 1243, 1246 and 1247 assigned to service layer 1240 may have a RUNS_ON relationship with VMs 1232, 1234, 1236 and 1238, respectively.

In some examples, graph portion 1200 also shows relationships between element nodes assigned to a same logical layer. For example, VM 1232 has a REQUIRES relationship with VM 1234, VM 1234 has a REQUIRES relationship with VM 1236 and VM 1236 has a REQUIRES relationship with VM 1238. According to some examples, a REQUIRES relationship may be due to VMs supporting a multi-threaded programming model possibly associated with service chain processing or other types of implementations of multi-threaded programming models that may involve separate VMs executing at least a portion of a service and then handing additional processing off to another VM.

According to some example, graph portion 1200 also shows relationships between various service element nodes assigned to service layer 1240. For these examples, if a service has a relationship of DEPENDS_ON, these services may depend on processed outputs from other services. For examples, service 1247 DEPENDS_ON service 1246 and thus may depend on a processed output from service 1246 to execute a service.

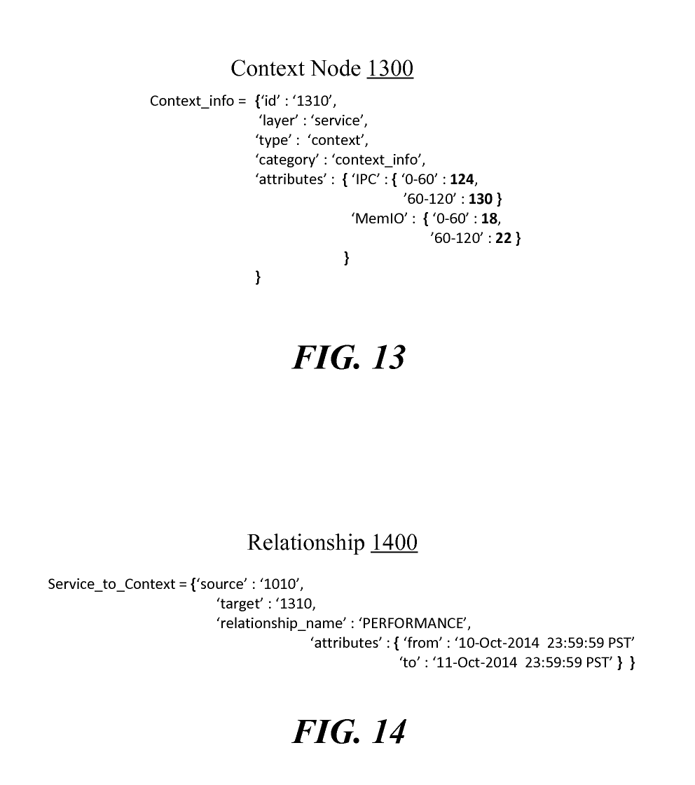

FIG. 13 illustrates an example context node 1300. According to some examples, contextualized information for one or more elements of a system of configurable computing resources of a cloud infrastructure (e.g., cloud infrastructure 100) may be received that indicates performance parameters for each of the one or more elements. For these examples, the contextualized information for each of the one or more elements may be added to a graph model (e.g., generated by a graph manager) as separate context nodes having similar information as shown in FIG. 13 for context node 1300. The similar information may include metadata and attributes based on queried information, an assigned logical layer for a respective element from among the one or more elements and the contextualized information received.

According to some examples, as shown in FIG. 13, context metadata for context node 1300 may indicate an ‘id’ or identifier of 1310, a ‘layer’ or assigned layer of service, a ‘type’ that indicates a context type of node and a ‘category’ of context_info. In some examples, context node 1300 may also have attributes that indicate performance parameters for each of the one or more elements. For example, as shown in FIG. 13, performance parameters of instruction per cycle (IPC) for a CPU may be included for a first 0-60 second interval and for a second 60-120 second interval. Also, performance parameters for memory input-output (MemIO) for a memory may be included for the same first and second intervals. More or less performance parameters may be included in the attributes for a context node, examples are not limited to the performance parameters shown in FIG. 13 for context node 1300.

FIG. 14 illustrates an example fourth relationship. As shown in FIG. 14, the fourth relationship includes relationship 1400. According to some examples, relationship 1400 may be determined by logic and/or features that generate the graph model including at least context node 1300 and an element node associated with this relationship. As shown in FIG. 14, the element node associated with relationship is indicated as a source 1010 which is element node 1000 shown in FIG. 10. For these examples, a relationship between the context (target 1310) for context node 1300 and the service (source 1010) for element node 1000 may be determined. Since this is a relationship with a context node, the relationship may be determined to be a PERFORMANCE relationship as indicated by that ‘relationship_name’ in FIG. 14.

According to some examples, similar to relationship 700 shown in FIG. 7, relationship 1400 may track date and times for which a relationship between the service and context was maintained. As shown in FIG. 14, ‘from’ may indicate a date/time the relationship began as 1 Feb. 2014 at 12:33:45 PST. Also, as shown in FIG. 14, ‘to’ may indicate a date/time the relationship ended as 1 Feb. 2014 at 15:12:54 PST. This tracking of the date/times for a relationship such as relationship 1400 may allow for a date-based version of the graph model that includes at least element node 1000 and context node 1300. The date-based version may allow for historical tracking of what the graph model may look at during given periods of time and also allow for historical tracking of performance parameters for various elements of a cloud infrastructure during the given periods of time.

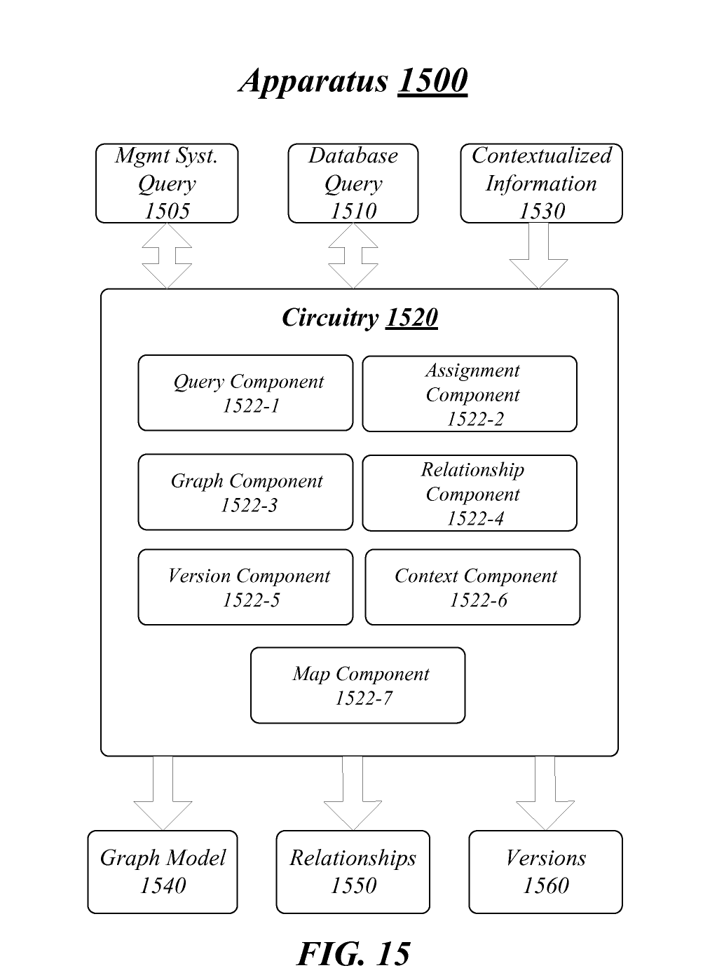

FIG. 15 illustrates an example block diagram for apparatus 1500. Although apparatus 1500 shown in FIG. 15 has a limited number of elements in a certain topology, it may be appreciated that the apparatus 1500 may include more or less elements in alternate topologies as desired for a given implementation.

According to some examples, apparatus 1500 may be supported by circuitry 1520 maintained at or with management elements for a system of configurable computing resources of a cloud infrastructure such as graph manager 170 shown in FIG. 1 for cloud infrastructure 100. Circuitry 1520 may be arranged to execute one or more software or firmware implemented modules or components 1522-a (module or component may be used interchangeably in this context). It is worthy to note that “a” and “b” and “c” and similar designators as used herein are intended to be variables representing any positive integer. Thus, for example, if an implementation sets a value for a=7, then a complete set of software or firmware for components 1522-a may include components 1522-1, 1522-2, 1522-3, 1522-4, 1522-5, 1522-6 or 1522-7. The examples presented are not limited in this context and the different variables used throughout may represent the same or different integer values. Also, these “components” may be software/firmware stored in computer-readable media, and although the components are shown in FIG. 15 as discrete boxes, this does not limit these components to storage in distinct computer-readable media components (e.g., a separate memory, etc.).

According to some examples, circuitry 1520 may include a processor, processor circuit or processor circuitry. Circuitry 1520 may be part of host processor circuitry that supports a management element for cloud infrastructure such as graph manager 170. Circuitry 1520 may be generally arranged to execute one or more software components 1522-a. Circuitry 1520 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 1520 may also include an application specific integrated circuit (ASIC) and at least some components 1522-a may be implemented as hardware elements of the ASIC.

In some examples, apparatus 1500 may include a query component 1522-1. Query component 1522-1 may be executed by circuitry 1520 to query information for elements of a system of configurable computing resources of a cloud infrastructure. For these examples, the query information may be obtained via management system query 1505 or from database query 1510. Management system query 1505, for example, may be information received from cloud infrastructure management elements such as cloud infrastructure management 150. Database query 1510, for example, may be information received from one or more databases that may include information regarding disaggregate PEs of the cloud infrastructure such as database(s) 160.

According to some examples, apparatus 1500 may also include an assignment component 1522-2. Assignment component 1522-2 may be executed by circuitry 1520 to assign a logical layer to each element of the system of configurable computing resources, the logical layer assigned from one of a physical layer, an allocation layer, a virtual layer or a service layer.

In some examples, apparatus 1500 may also include graph component 1522-3. Graph component 1522-3 may be executed by circuitry 1520 to add each element to a graph model as separate element nodes each having metadata and attributes that are based, at least in part, on the queried information and the assigned logical layer. For these examples, graph model 1540 may include the added elements to provide a landscape view of the cloud infrastructure.

According to some examples, apparatus 1500 may also include a relationship component 1522-4. Relationship component 1522-4 may be executed by circuitry 1520 to determine relationships between each element node added to the graph model and at least one other element in the graph model. For these examples, relationships 1550 may include these determined separate relationships.

In some examples, apparatus 1500 may also include a version component 1522-5. Version component 1522-5 may be executed by circuitry 1520 to establish a beginning time/date and an estimated ending time/date to generate a date-based version of the graph model for the separate relationships between each element node determined by relationship component 1522-4. For these examples, versions 1560 may include one or more date-based versions of the graph model that may provide a snapshot of the cloud infrastructure of one or more time intervals.

According to some examples, apparatus 1500 may also include a context component 1522-6. Context component 1522-6 may be executed by circuitry 1520 to receive contextualized information for one or more elements of the system of configurable computing resources that indicates performance parameters for each of the one or more elements. For these examples, contextualized information 1530 may include the contextualized information. Also for these examples, graph component 1522-3 may be capable of adding the contextualized information for each of the one or more elements to the graph model as separate context nodes. Each context node may have context metadata and context attributes based on the queried information, the assigned logical layer for a respective element from among the one or more elements and the contextualized information received by context component 1522-6 for the respective element.

According to some example, relationship component 1522-4 may also be capable of determining separate context relationships between each element node and a respective context node added to the graph model by graph component 1522-3. Also, version component 1522-5 may be capable of determining a beginning time/date and an estimated ending time/date to generate a date-based version of the graph model for the separate context relationships between each element node and the respective context node as determined by relationship component 1522-4.

In some examples, apparatus 1500 may also include a map component 1522-7. Map component 1522-7 may be executed by circuitry 1520 to map elements of the cloud infrastructure assigned to different logical layers. For example, individual disaggregate physical elements assigned to the physical layer may be mapped to the allocation layer based on whether an individual disaggregate physical element is included in the grouped disaggregate physical elements included in a respective logical server from among a group of separate logical servers. In another example, individual virtualized elements assigned to the virtual layer may be mapped to the allocation layer based on whether an individual virtualized element is supported by a respective logical server from among the separate logical servers. In another example, individual service or workload elements assigned to the service layer may be mapped to the virtual layer based on whether an individual service or workload element is executed or implemented by a respective virtualize element from among the virtualized elements.

Various components of apparatus 1500 and a device or node implementing apparatus 1500 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

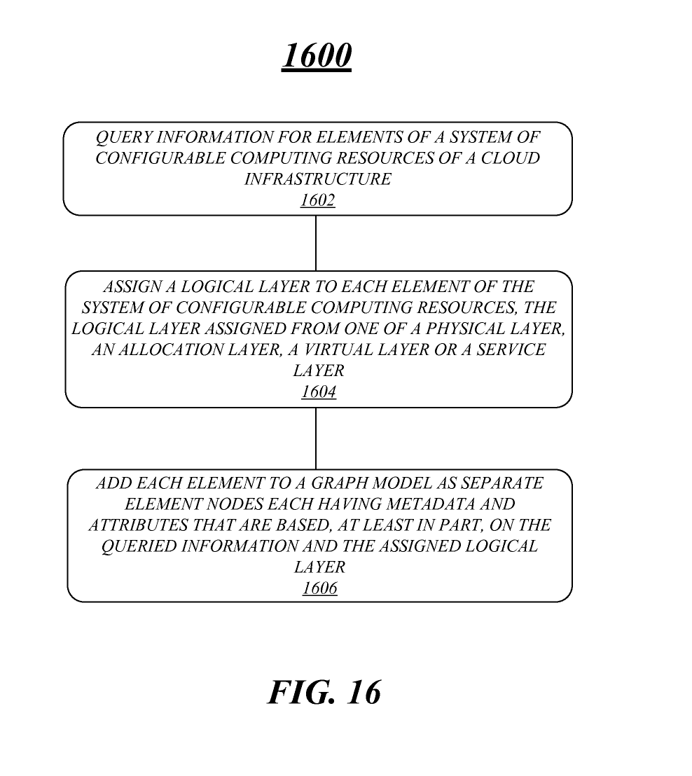

FIG. 16 illustrates an example logic flow 1600. Logic flow 1600 may be representative of some or all of the operations executed by one or more logic, features, or devices described herein, such as apparatus 1500. More particularly, logic flow 1600 may be implemented by at least query component 1522-1, assignment component 1522-2 or graph component 1522-3.

According to some examples, logic flow 1600 at block 1602 may query information for elements of a system of configurable computing resources of a cloud infrastructure. For these examples, query component 1522-1 may query the information from cloud infrastructure management and/or database(s) including information for the elements of the cloud infrastructure.

In some examples, logic flow 1600 at block 1604 may assign a logical layer to each element of the system of configurable computing resources, the logical layer assigned from one of a physical layer, an allocation layer, a virtual layer or a service layer. For these examples, assignment component 1522-2 may assign the logical layer to each element.

According to some examples, logic flow 1600 at block 1606 may add each element to a graph model as separate element nodes each having metadata and attributes that are based, at least in part, on the queried information and the assigned logical layer. For these examples, graph component 1522-3 may add each element to the graph model.

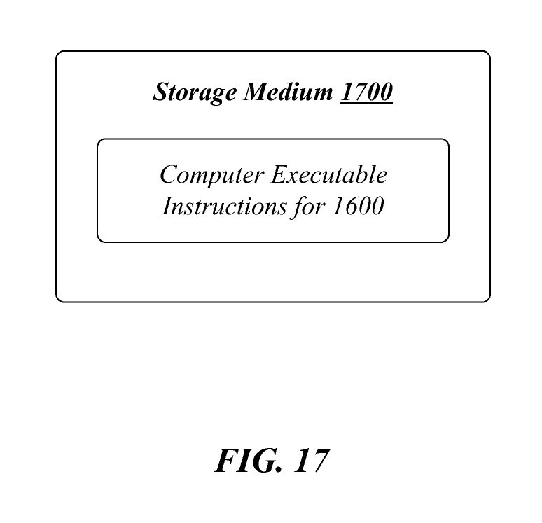

FIG. 17 illustrates an example storage medium 1700. As shown in FIG. 17, the first storage medium includes a storage medium 1700. The storage medium 1700 may comprise an article of manufacture. In some examples, storage medium 1700 may include any non-transitory computer readable medium or machine readable medium, such as an optical, magnetic or semiconductor storage. Storage medium 1700 may store various types of computer executable instructions, such as instructions to implement logic flow 1600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

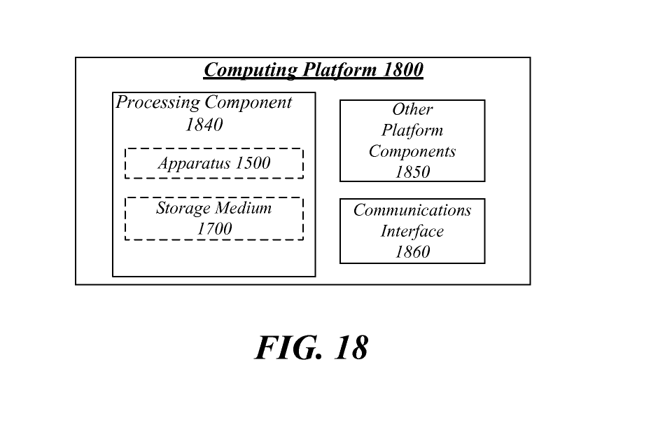

FIG. 18 illustrates an example computing platform 1800. In some examples, as shown in FIG. 18, computing platform 1800 may include a processing component 1840, other platform components 1850 or a communications interface 1860. According to some examples, computing platform 1800 may host management elements (e.g., graph manager) providing management functionality for a system of configurable computing resources of a cloud infrastructure such as cloud infrastructure 100 of FIG. 1.

According to some examples, processing component 1840 may execute processing operations or logic for apparatus 1500 and/or storage medium 1700. Processing component 1840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1850 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1860 may include logic and/or features to support a communication interface. For these examples, communications interface 1860 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Hardware Abstraction API Specification. Network communications may also occur according to Infiniband Architecture specification.

As mentioned above computing platform 1800 may be implemented in a server or client computing device. Accordingly, functions and/or specific configurations of computing platform 1800 described herein, may be included or omitted in various embodiments of computing platform 1800, as suitably desired for a server or client computing device.

The components and features of computing platform 1800 may be implemented using any combination of discrete circuitry, application specific integrated circuits (ASICs), logic gates and/or single chip architectures. Further, the features of computing platform 1800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 1800 shown in the block diagram of FIG. 18 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include circuitry and a query component for execution by the circuitry that may query information for elements of a system of configurable computing resources of a cloud infrastructure. The apparatus may also include an assignment component for execution by the circuitry that may assign a logical layer to each element of the system of configurable computing resources. The logical layer may be assigned from one of a physical layer, an allocation layer, a virtual layer or a service layer. The apparatus may also include a graph component for execution by the circuitry that may add each element to a graph model as separate element nodes each having metadata and attributes that are based, at least in part, on the queried information and the assigned logical layer.

### Example 2

The apparatus of example 1 may also include a relationship component for execution by the circuitry that may determine relationships between each element node added to the graph model and at least one other element in the graph model. The apparatus may also include a version component for execution by the circuitry that may establish a beginning time/date and an estimated ending time/date to generate a date-based version of the graph model for the separate relationships between each element node determined by the relationship component.

### Example 3

The apparatus of example 1 may also include a context component for execution by the circuitry that may receive contextualized information for one or more elements of the system of configurable computing resources that indicates performance parameters for each of the one or more elements. For these examples, the graph component may add the contextualized information for each of the one or more elements to the graph model as separate context nodes. Also, each context node may have context metadata and context attributes based on the queried information. The assigned logical layer for a respective element may be from among the one or more elements and the contextualized information received by the context component for the respective element.

### Example 4

The apparatus of example 3, the context metadata including a unique identifier, assigned logical layer, a type that indicates context node or a category that indicates context information. For these examples, the attributes may include the performance parameters as indicated in received contextualized information for the respective element.

### Example 5

The apparatus of example 3 may also include a relationship component for execution by the circuitry that may determine separate context relationships between each element node and a respective context node added to the graph model by the graph component. The apparatus may also include a version component for execution by the circuitry that may establish a beginning time/date and an estimated ending time/date to generate a date-based version of the graph model for the separate context relationships between each element node and the respective context node as determined by the relationship component.

### Example 6

The apparatus of example 1, the query component may query information for elements of the system of configurable computing resources from a cloud infrastructure management system and from separate databases for network elements, storage elements or compute elements included in the system of configurable computing resources.

### Example 7

The apparatus of example 1, the metadata including a unique identifier, assigned logical layer, a type of node, a category that includes one of compute, storage or network. For these examples, the attributes may include operating characteristics or capabilities.

### Example 8

The apparatus of example 1, the elements of the system of configurable computing resources including individual disaggregate physical elements, placed disaggregate physical elements, virtualized elements, service elements or workload elements.

### Example 9

The apparatus of example 8, the assignment component to assign the logical layer to each element of the system of configurable computing resources may include the assignment component to assign individual disaggregate physical elements to the physical layer. The assignment component may also assign the placed disaggregate physical elements to the allocation layer. The assignment component may also assign the virtualized elements to the virtual layer and assign the service or workload elements to the service layer.

### Example 10

The apparatus of example 9, the placed disaggregated physical elements including separate logical servers assigned to the allocation layer. The apparatus may further include a map component for execution by the circuitry that may map individual disaggregate physical elements assigned to the physical layer to the allocation layer based on whether an individual disaggregate physical element is included in the placed disaggregate physical elements included in a respective logical server from among the separate logical servers.

### Example 11

The apparatus of example 10, the separate logical servers may each be arranged to support one or more virtualized elements. For these examples, the apparatus may further include the map component to map individual virtualized elements assigned to the virtual layer to the allocation layer based on whether an individual virtualized element is supported by a respective logical server from among the separate logical servers.

### Example 12

The apparatus of example 11, each virtualized element from among the one or more virtualized elements may be arranged to implement one or more service or workload elements. For these examples, the apparatus may further include the map component to map individual service or workload elements assigned to the service layer to the virtual layer based on whether an individual service or workload element is implemented by a respective virtualized element from among the virtualized elements.

### Example 13

The apparatus of example 8, the disaggregate physical elements may include central processing units, memory devices, storage devices, network input/output devices or network switches.

### Example 14

The apparatus of example 8, the virtualized elements may include virtual machines, virtual local access networks, virtual switches, virtual local access networks or logically assigned block storage.

### Example 15

The apparatus of example 8, the service elements may include management services, message queue services or security services.

### Example 16

The apparatus of example 8, the workload elements may include database, webserver or video processing workloads.

### Example 17

The apparatus of example 1 may also include a digital display coupled to the circuitry to present a user interface view.

### Example 18

An example method may include querying, at a processor circuit, information for elements of a system of configurable computing resources of a cloud infrastructure. The example method may also include assigning a logical layer to each element of the system of configurable computing resources. The logical layer may be assigned from one of a physical layer, an allocation layer, a virtual layer or a service layer. The example method may also include adding each element to a graph model as separate element nodes each having metadata and attributes that are based, at least in part, on the queried information and the assigned logical layer.

### Example 19

The method of example 18 may also include determining relationships between each element node added to the graph model and at least one other element in the graph model and establishing a beginning time/date and an estimated ending time/date to generate a date-based version of the graph model for the separate relationships between each element node.

### Example 20

The method of example 18 may also include receiving contextualized information for one or more elements of the system of configurable computing resources that indicates performance parameters for each of the one or more elements. The example method may also include adding the contextualized information for each of the one or more elements to the graph model as separate context nodes. For these examples, each context node may have context metadata and context attributes based on the queried information. The assigned logical layer for a respective element may be from among the one or more elements and the contextualized information may be received for the respective element.

### Example 21

The method of example 20, the context metadata including a unique identifier, assigned logical layer, a type that indicates context node, a category that indicates context information. For these examples, the attributes may include the performance parameters as indicated in received contextualized information for the respective element.

### Example 22

The method of example 20 may also include determining separate context relationships between each element node and a respective context node added to the graph model. The example method may also include establishing a beginning time/date and an estimated ending time/date to generate a date-based version of the graph model for the separate context relationships between each element node and the respective context node.

### Example 23

The method of example 18, the information may be queried from a cloud infrastructure management system and from separate databases for network elements, storage elements or compute elements included in the system of configurable computing resources.

### Example 24

The method of example 18, the metadata including a unique identifier, assigned logical layer, a type of node, a category that includes one of compute, storage or network. For these examples, the attributes may include operating characteristics or capabilities.

### Example 25

The method of example 18, the elements of the system of configurable computing resources including individual disaggregate physical elements, placed disaggregate physical elements, virtualized elements, service elements or workload elements.

### Example 26

The method of example 25, assigning the logical layer to each element of the system of configurable computing resources may include the individual disaggregate physical elements assigned to the physical layer, the placed disaggregate physical elements assigned to the allocation layer, the virtualized elements assigned to the virtual layer and the service or workload elements assigned to the service layer.

### Example 27

The method of example 26, the placed disaggregated physical elements including separate logical servers assigned to the allocation layer. The method may further include mapping individual disaggregate physical elements assigned to the physical layer to the allocation layer based on whether an individual disaggregate physical element is included in the placed disaggregate physical elements included in a respective logical server from among the separate logical servers.

### Example 28

The method of example 27, the separate logical servers each arranged to support one or more virtualized elements. For these examples, the method may further include mapping individual virtualized elements assigned to the virtual layer to the allocation layer based on whether an individual virtualized element is supported by a respective logical server from among the separate logical servers.

### Example 29

The method of example 28, each virtualized elements from among the one or more virtualized elements may be arranged to implement one or more service or workload elements. The method may further include mapping individual service or workload elements assigned to the service layer to the virtual layer based on whether an individual service or workload element is implemented by a respective virtualized element from among the virtualized elements.

### Example 30

The method of example 25, the disaggregate physical elements may include central processing units, memory devices, storage devices, network input/output devices or network switches.

### Example 31

The method of example 25, the virtualized elements may include virtual machines, virtual local access networks, virtual switches, virtual local access networks, or logically assigned block storage.

### Example 32

The method of example 25, the service elements may include management services, message queue services or security services.

### Example 33

The method of example 25, the workload elements may include database, webserver or video processing workloads.

### Example 34

An example at least one machine readable medium may include a plurality of instructions that in response to being executed by system at a server may cause the system to carry out a method according to any one of examples 18 to 33.

### Example 35

An example apparatus may include means for performing the methods of any one of examples 18 to 33.

### Example 36

An example at least one machine readable medium may include a plurality of instructions that in response to being executed by circuitry located with a system of configurable computing resources of a cloud infrastructure may cause the circuitry to query information for elements of the system of configurable computing resources of the cloud infrastructure. The instructions may also cause the circuitry to assign a logical layer to each element of the system of configurable computing resources, the logical layer assigned from one of a physical layer, an allocation layer, a virtual layer or a service layer. The instructions may also cause the circuitry to add each element to a graph model as separate element nodes each having metadata and attributes that are based, at least in part, on the queried information and the assigned logical layer.

### Example 37

The at least one machine readable medium of example 36, the instructions may also cause the circuitry to determine relationships between each element node added to the graph model and at least one other element in the graph model. The instructions may also cause the circuitry to establish a beginning time/date and an estimated ending time/date to generate a date-based version of the graph model for the separate relationships between each element node.

### Example 38

The at least one machine readable medium of example 36, the instructions may further cause the circuitry to receive contextualized information for one or more elements of the system of configurable computing resources that indicates performance parameters for each of the one or more elements. The instructions may also cause the circuitry to add the contextualized information for each of the one or more elements to the graph model as separate context nodes. For these examples, each context node may have context metadata and context attributes based on the queried information, the assigned logical layer for a respective element from among the one or more elements and the contextualized information received for the respective element.

### Example 39

The at least one machine readable medium of example 38, the context metadata including a unique identifier, assigned logical layer, a type that indicates context node, a category that indicates context information. For these examples, the attributes may include the performance parameters as indicated in received contextualized information for the respective element.

### Example 40

The at least one machine readable medium of example 38, the instructions may further cause the circuitry to determine separate context relationships between each element node and a respective context node added to the graph model. The instructions may also cause the circuitry to establish a beginning time/date and an estimated ending time/date to generate a date-based version of the graph model for the separate context relationships between each element node and the respective context node.

### Example 41

The at least one machine readable medium of example 36, the information may be queried from a cloud infrastructure management system and from separate databases for network elements, storage elements or compute elements included in the system of configurable computing resources.

### Example 42

The at least one machine readable medium of example 36, the metadata including a unique identifier, assigned logical layer, a type of node, a category that includes one of compute, storage or network. For these examples, the attributes may include operating characteristics or capabilities.

### Example 43

The at least one machine readable medium of example 36, the elements of the system of configurable computing resources including individual disaggregate physical elements, placed disaggregate physical elements, virtualized elements, service elements or workload elements.

### Example 44

The at least one machine readable medium of example 43, to assign the logical layer to each element of the system of configurable computing resources may include the individual disaggregate physical elements being assigned to the physical layer, the placed disaggregate physical elements being assigned to the allocation layer, the virtualized elements being assigned to the virtual layer and the service or workload elements being assigned to the service layer.

### Example 45

The at least one machine readable medium of example 44, the placed disaggregated physical elements including separate logical servers assigned to the allocation layer. For these examples, the instructions may further cause the circuitry to map individual disaggregate physical elements assigned to the physical layer to the allocation layer based on whether an individual disaggregate physical element is included in the placed disaggregate physical elements included in a respective logical server from among the separate logical servers.

### Example 46

The at least one machine readable medium of example 45, the separate logical servers may each be arranged to support one or more virtualized elements. For these examples, the instructions may further cause the circuitry to map individual virtualized elements assigned to the virtual layer to the allocation layer based on whether an individual virtualized element is supported by a respective logical server from among the separate logical servers.

### Example 47

The at least one machine readable medium of example 46, each virtualized elements from among the one or more virtualized elements may be arranged to implement one or more service or workload elements. For these examples, the instructions may further cause the circuitry to map individual service or workload elements assigned to the service layer to the virtual layer based on whether an individual service or workload element is implemented by a respective virtualized element from among the virtualized elements.

### Example 48

The at least one machine readable medium of example 43, the disaggregate physical elements may include central processing units, memory devices, storage devices, network input/output devices or network switches.

### Example 49

The at least one machine readable medium of example 43, the virtualized elements may include virtual machines, virtual local access networks, virtual switches, virtual local access networks, or logically assigned block storage.

### Example 50

The at least one machine readable medium of example 43, the service elements may include management services, message queue services or security services.

### Example 51

The at least one machine readable medium of example 43, the workload elements may include database, webserver or video processing workloads.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry;
a query component for execution by the circuitry to query information for elements of a system of configurable computing resources of a cloud infrastructure;
an assignment component for execution by the circuitry to assign a logical layer to each element of the system of configurable computing resources, the logical layer assigned from one of a physical layer, an allocation layer, a virtual layer or a service layer; and
a graph component for execution by the circuitry to add each element to a graph model as separate element nodes each having metadata and attributes that are based, at least in part, on the queried information and the assigned logical layer.

2. The apparatus of claim 1, comprising:
a relationship component for execution by the circuitry to determine relationships between each element node added to the graph model and at least one other element in the graph model; and
a version component for execution by the circuitry to establish a beginning time/date and an estimated ending time/date to generate a date-based version of the graph model for the separate relationships between each element node determined by the relationship component.

3. The apparatus of claim 1, comprising:
a context component for execution by the circuitry to receive contextualized information for one or more elements of the system of configurable computing resources that indicates performance parameters for each of the one or more elements; and
the graph component to add the contextualized information for each of the one or more elements to the graph model as separate context nodes, each context node having context metadata and context attributes based on the queried information, the assigned logical layer for a respective element from among the one or more elements and the contextualized information received by the context component for the respective element.

4. The apparatus of claim 3, the context metadata including a unique identifier, assigned logical layer, a type that indicates context node, a category that indicates context information or the attributes including the performance parameters as indicated in received contextualized information for the respective element.

5. The apparatus of claim 3, comprising:
a relationship component for execution by the circuitry to determine separate context relationships between each element node and a respective context node added to the graph model by the graph component;
a version component for execution by the circuitry to establish a beginning time/date and an estimated ending time/date to generate a date-based version of the graph model for the separate context relationships between each element node and the respective context node as determined by the relationship component.

6. The apparatus of claim 1, comprising the query component to query information for elements of the system of configurable computing resources from a cloud infrastructure management system and from separate databases for network elements, storage elements or compute elements included in the system of configurable computing resources.

7. The apparatus of claim 1, the metadata including a unique identifier, assigned logical layer, a type of node, a category that includes one of compute, storage or network, the attributes including operating characteristics or capabilities.

8. The apparatus of claim 1, the elements of the system of configurable computing resources including individual disaggregate physical elements, placed disaggregate physical elements, virtualized elements, service elements or workload elements.

9. The apparatus of claim 8, the assignment component to assign the logical layer to each element of the system of configurable computing resources comprises the assignment component to:
assign individual disaggregate physical elements to the physical layer;
assign the placed disaggregate physical elements to the allocation layer;
assign the virtualized elements to the virtual layer; and
assign the service or workload elements to the service layer.

10. The apparatus of claim 9, the placed disaggregated physical elements including separate logical servers assigned to the allocation layer, the apparatus further comprising:
a map component for execution by the circuitry to map individual disaggregate physical elements assigned to the physical layer to the allocation layer based on whether an individual disaggregate physical element is included in the placed disaggregate physical elements included in a respective logical server from among the separate logical servers.

11. The apparatus of claim 10, the separate logical servers each arranged to support one or more virtualized elements, the apparatus further comprising:
the map component to map individual virtualized elements assigned to the virtual layer to the allocation layer based on whether an individual virtualized element is supported by a respective logical server from among the separate logical servers.

12. The apparatus of claim 11, each virtualized elements from among the one or more virtualized elements is arranged to implement one or more service or workload elements, the apparatus further comprising:
the map component to map individual service or workload elements assigned to the service layer to the virtual layer based on whether an individual service or workload element is implemented by a respective virtualized element from among the virtualized elements.

13. The apparatus of claim 8, the disaggregate physical elements comprising central processing units, memory devices, storage devices, network input/output devices or network switches.

14. The apparatus of claim 8, the virtualized elements comprising virtual machines, virtual local access networks, virtual switches, virtual local access networks or logically assigned block storage.

15. The apparatus of claim 8, the service elements comprising management services, message queue services or security services.

16. The apparatus of claim 8, the workload elements comprising database, webserver or video processing workloads.

17. The apparatus of claim 1, comprising a digital display coupled to the circuitry to present a user interface view.

18. A method comprising:
querying, at a processor circuit, information for elements of a system of configurable computing resources of a cloud infrastructure;
assigning a logical layer to each element of the system of configurable computing resources, the logical layer assigned from one of a physical layer, an allocation layer, a virtual layer or a service layer; and
adding each element to a graph model as separate element nodes each having metadata and attributes that are based, at least in part, on the queried information and the assigned logical layer.

19. The method of claim 18, comprising:
determining relationships between each element node added to the graph model and at least one other element in the graph model; and
establishing a beginning time/date and an estimated ending time/date to generate a date-based version of the graph model for the separate relationships between each element node.

20. The method of claim 18, comprising:
receiving contextualized information for one or more elements of the system of configurable computing resources that indicates performance parameters for each of the one or more elements;
adding the contextualized information for each of the one or more elements to the graph model as separate context nodes, each context node having context metadata and context attributes based on the queried information, the assigned logical layer for a respective element from among the one or more elements and the contextualized information received for the respective element;
determining separate context relationships between each element node and a respective context node added to the graph model; and
establishing a beginning time/date and an estimated ending time/date to generate a date-based version of the graph model for the separate context relationships between each element node and the respective context node.

21. The method of claim 18, the elements of the system of configurable computing resources including individual disaggregate physical elements, placed disaggregate physical elements, virtualized elements, service elements or workload elements.

22. At least one machine readable medium comprising a plurality of instructions that in response to being executed by circuitry located with a system of configurable computing resources of a cloud infrastructure cause the circuitry to:
query information for elements of the system of configurable computing resources of the cloud infrastructure;
assign a logical layer to each element of the system of configurable computing resources, the logical layer assigned from one of a physical layer, an allocation layer, a virtual layer or a service layer; and
add each element to a graph model as separate element nodes each having metadata and attributes that are based, at least in part, on the queried information and the assigned logical layer.

23. The at least one machine readable medium of claim 22, the instructions to further cause the circuitry to:
determine relationships between each element node added to the graph model and at least one other element in the graph model; and
establish a beginning time/date and an estimated ending time/date to generate a date-based version of the graph model for the separate relationships between each element node.

24. The at least one machine readable medium of claim 22, the instructions to further cause the circuitry to:
receive contextualized information for one or more elements of the system of configurable computing resources that indicates performance parameters for each of the one or more elements;
add the contextualized information for each of the one or more elements to the graph model as separate context nodes, each context node having context metadata and context attributes based on the queried information, the assigned logical layer for a respective element from among the one or more elements and the contextualized information received for the respective element;
determine separate context relationships between each element node and a respective context node added to the graph model; and
establish a beginning time/date and an estimated ending time/date to generate a date-based version of the graph model for the separate context relationships between each element node and the respective context node.

25. The at least one machine readable medium of claim 22, the elements of the system of configurable computing resources including individual disaggregate physical elements, placed disaggregate physical elements, virtualized elements, service elements or workload elements.
